(19) United States
(12) Patent Application Publication
(10) Pub. No.: US 2018/0326394 A1
(43) Pub. Date: Nov. 15, 2018

(54) CAPTURE AGENT FOR THE TREATMENT OF FLUE GASES

(71) Applicant: CARMEUSE RESEARCH AND TECHNOLOGY, Louvain-la-neuve (BE)

(72) Inventors: Louis Masset, Fleron (BE); Bernard Somerhausen, Nivelles (BE)

(21) Appl. No.: 15/776,319

(22) PCT Filed: Oct. 18, 2016
(86) PCT No.: PCT/EP2016/074961

§ 371 Date: May 15, 2018

(30) Foreign Application Priority Data
Nov. 16, 2015 (BE) 2015/5744

(51) Int. Cl. B01J 20/10; C01B 33/24; B01J 20/04; B01J 20/02; B01J 20/22; B01J 20/28; B01J 20/30; B01D 53/04

(52) U.S. Cl. CPC B01J 20/10; B01D 2257/302; B01J 20/046; B01J 20/0229; B01J 20/0288; B01J 20/22; B01J 20/28061; B01J 20/28073; B01J 20/28004; B01J 20/28016; B01J 20/3085; B01D 53/04; C01P 2006/12; C01P 2006/14; C01P 2004/61; B01D 2253/106; B01D 2253/304; C01B 33/24

(57) ABSTRACT

The present invention relates to a capture agent for the treatment of gases, having an active phase that comprises a calcium silicate hydrate of (CaO)ₓ(SiO₂)_{y}(H₂O)_{z} type with a Ca/Si molar ratio between 1.55 and 1.72, preferably between 1.65 and 1,72 and an H₂O/Ca molar ratio between 1 and 1.4, preferably between 1.1 and 1.3, “z” being between 0.3 and 0.8, the capture agent having a specific surface area greater than 120 m²/g, preferably greater than 150 m²/g and particularly preferably greater than 200 m²/g and a pore volume greater than 0.4 cm³/g, preferably greater than 0.6 cm³/g and particularly preferably greater than 0.8 cm³/g.

### SUBJECT-MATTER OF THE INVENTION

The present invention concerns a solid sorbent for the treatment of flue gases and a method for preparing said agent. The present invention also relates to a process for treating flue gases with said sorbent.

### STATE OF THE ART

Numerous industrial processes emit gases containing acidic compounds such as SO₂, SO₃, HCl, HBr and HF . . . For best prevented release of these acidic compounds into the atmosphere, considerable efforts have already been made to develop and improve flue-gas treatment processes.

Among known treatment processes, several have recourse to a solid agent called a sorbent. For the uptake of the acid compounds contained in these gases, this sorbent is placed in contact with the gases to purified, either in powder form or in the form of particles in a liquid suspension.

According to a first treatment process called “wet process”, the gases are scrubbed in an absorber using an aqueous suspension of a sorbent. The captured acidic compounds are recovered in the suspension leaving the absorber, in the form of reaction products combined with the sorbent. For example, captured SO₂ and SO₃ are recovered in this suspension in the form of sulfites and/or sulfates.

According to a second treatment process called “semi-wet” process, the aqueous suspension of a sorbent is injected into the absorber in droplet form. The flow rate and concentration of sorbent in said suspension and the temperature of the gases to be treated are such that the water contained in the suspension is evaporated and carried by the gases. The captured acidic compounds are recovered in the form of reaction products in solid residues.

According to a third treatment process called “dry process”, the gases are placed in direct contact with a solid sorbent, either by dry injection of said sorbent into the absorber or into an entrained bed, or by maintaining the sorbent in a fluidised bed. It is also possible to cause the gasses to pass through a fixed bed of sorbent. The captured compounds are then present in the form of reaction products in the solid residue. Conventionally, for solid sorbents, use is made of compounds containing calcium in a form that can react with the acidic compounds.

Among the acidic compounds, SO₂ is generally the most difficult to capture by chemical reaction on account of its less-marked acidic nature. Therefore, a basic sorbent which efficiently captures SO₂ will therefore also capture more acidic compounds such as HCl, HBr, HF and SO₃. As a result, sorbents can be evaluated through their capacity to capture SO₂ on the understanding that they also capture the other above-mentioned acidic compounds. This approach is also adopted in the present description.

One first example of a known solid sorbent is calcium hydroxide. The reaction between Ca(OH)₂ and SO₂ contained in the gases is promoted by high humidity, such as that encountered for example in wet processes or semi-wet processes. To reach acceptable SO₂ capture when implementing the so-called “dry” process, it is generally recognized that the injection of water into the gases in association with Ca(OH)₂ improves the performance of the process.

One major disadvantage of Ca(OH)₂ is its pasty consistency when associated with high relative humidity. This leads to the formation of solid deposits in installations and increases the risk of fouling, compelling the user to treat the gases under conditions of low relative humidity and hence under non-optimal conditions for gas treatment. The thickening of Ca(OH)₂ particle paste is greater the lower the porosity.

Another disadvantage of Ca(OH)₂ used in a dry process is its lack of selectivity (major capture of CO₂), its limited reactivity in respect of SO₂ and its large tendency to passivate.

It has also been noted that when treating gases, the reactivity of a Ca(OH)₂ agent present in the form of granules drops to a very low level although it still contains a significant amount of Ca(OH)₂ that has not reacted with the compounds of the gas to be purified. In practice, it is found that Ca(OH)₂ must be used in large excess for gas treatment, which also leads to a high amount of waste for disposal.

Other known solid sorbents are calcium silicate hydrates of formula (CaO)ₓ(SiO₂)_{y}(H₂O)_{z} containing varying amounts of free water.

DE-OS-3611769 proposes to use, as sorbent, a granulate of lime-rich calcium silicate hydrate such as derived from the manufacture of concrete, this agent preferably having high porosity.

The semi-wet process described in U.S. Pat. No. 4,804,521 uses as sorbent, a calcium silicate hydrate or calcium aluminate hydrate, prepared by reacting an aqueous suspension containing an alkaline calcium compound (CaO or Ca(OH)₂) with a silica or alumina.

In the dry process described in U.S. Pat. No. 5,100,643, a fluid, semi-dry powder containing such a calcium silicate is injected into the gas. A method to prepare such a semi-dry powder is described in U.S. Pat. No. 5,401,481.

With the known sorbents based on calcium silicate hydrates it is observed that the residues of these sorbents after reaction may contain a significant fraction of calcium that has not reacted during gas treatment, to an extent that an excess of sorbent is generally needed, again leading to excess solid waste. To overcome this problem, it is proposed in U.S. Pat. No. 4,804,521, U.S. Pat. No. 5,100,643 and U.S. Pat. No. 5,401,481 to recycle, at least in part, the solid residues from the treatment process, such residues possibly still comprising fly ash containing silica. Thus, these solid residues are added to the aqueous suspension in which the calcium silicate hydrate is prepared.

A large number of calcium silicate hydrates are known having different compositions and crystalline structures. A detailed study of different calcium silicate hydrates, the structures and methods of preparation thereof can be found in Chapter 5 of “The Calcium Silicate Hydrates” in “The Chemistry of Cements” edited by H. F. W. Taylor and published by the Academy Press in 1964. Among calcium silicate hydrates, crystalline compounds are found such as tobermorite, xonotlite, foshagite, afwillite, hillebrandite in particular, and compounds that are or ill or little crystallized such as CSH(I) and CSH (II) in particular.

Document WO 00/48710 discloses sorbents comprising calcium silicate hydrates in a pre-tobermorite phase having a Ca/Si molar ratio of between 1 and 5, H₂O/Ca molar ratio between 0.1 and 2 and a particle size of between 0.5 and 30 mm. The sorbent is obtained from cristobalite and quartz. This type of product is produced in an aqueous suspension and the drying operation to obtain a dry product represents a considerably high cost.

### Aims of the Invention

The present invention aims to overcome the drawbacks of sorbents known in the state of the art and to propose a sorbent with improved efficiency comprising calcium silicate hydrate with Ca/Si and Ca/H₂O molar ratios contained within a narrow range and a particularly fine particle size.

The invention also proposes a method to manufacture the sorbent and a process to purify flue gases using the sorbent as in the invention.

### SUMMARY OF THE INVENTION

The present invention discloses a sorbent to treat gases, with an active phase comprising a calcium silicate hydrate of (CaO)ₓ(SiO₂)_{y}(H₂O), type with a Ca/Si molar ratio of between 1.55 and 1.72, preferably between 1.65 and 1.72, and a H₂O/Ca molar ratio of between 1 and 1.4, preferably between 1.1 and 1.3, “z” being between 0.3 and 0.8, the sorbent having a specific surface area larger than 120 m²/g, preferably larger than 150 m²/g and most preferably larger than 200 m²/g with a pore volume greater than 0.4 cm³/g, preferably greater than 0.6 cm³/g and most preferably greater than 0.8 cm³/g.

The preferred embodiments of the invention comprise at least one, or any suitable combination of the following characteristics:
the mean particle size (D50) is less than 1000 μm, preferably less than 500 μm, and more preferably less than 300 μm;
said sorbent also comprises sodium chloride, calcium chloride or iron chloride hydrate within its pores;
said sorbent further comprises a fluidifying agent selected from among monoethanol amine, diethanol-amine, triethanol-amine, monoethylene-glycol, diethylene glycol and triethylene-glycol.

The invention also discloses a method for preparing a sorbent as in the invention, wherein the calcium silicate hydrate is obtained by:
preparing an aqueous suspension of silica and lime, from colloidal silica, silica fume or diatomaceous earth;
drying under heat.

According to preferred embodiments of the invention, the preparation of colloidal silica, silica fume or diatomaceous earth, or a mixture of these ingredients, comprises at least one of the following steps:
prior milling until particles with a d₅₀ diameter of less than 30 μm are obtained;
adding freshly synthesised colloidal silica in a proportion of 1 to 5%, preferably 2 to 4% before CSH is synthesized;
adding chlorine salt, preferably sodium chloride, calcium chloride or iron chloride.

The invention also discloses a process for treating gases by placing the sorbent of the invention in contact with the gases to be treated.

According to one preferred embodiment of the invention, the gas-treatment process is a dry process whereby the gases are placed in direct contact with the sorbent, the gas to be treated preferably passing through an electro-filter or bag filter containing this sorbent.

The efficiency of the sorbent as in the invention is evaluated by measuring the concentration of SO₂ as indicator compound, in the gases leaving the electro-filter or bag filter, and the sorbent is replaced when the concentration exceeds a previously-set limit value.

### DETAILED DESCRIPTION OF THE INVENTION

It is the aim of the present invention to provide a sorbent based on calcium silicate hydrate (CSH), or on a composition with calcium silicate hydrate in powder form for the treatment of flue gases, and a method for manufacturing this product. The invention also discloses a process to purify flue gases using the sorbent of the present invention.

Calcium silicate hydrates (CSH) are generally characterized by CaO/SiO₂ and H₂O/CaO molar ratios, and by their structural characteristics such as microstructure (CSH of type α, β or γ), Ca(OH)₂ content, water molecule stability, pore volume (PV), pore size, specific surface area (BET) and CO₂ content. Low uptake capacity of CO₂ is a highly desired property insofar as the gases to be purified are generally combustion gases with much higher contents of CO₂ than SO₂ or HCl for example (10% CO₂ compared with 0.2% SO₂ for example).

Besides, some properties are only obtained under specific synthesis conditions involving T°, time, pressure and the additives used.

To obtain maximum uptake efficiency of SO₂, SO₃, HCl, HF and even of some heavy metals, and optimal stability of the product, it is also generally desired to obtain frost resistance properties in spite of its high content of residual water (3-day test at −20° C.) and optimal flow (measured by the cohesion index at increasing and decreasing speeds in the Granu-Drum by Aptis).

To reach these characteristics, the particle size of the CSHs as in the invention must not exceed a mean (D50), measured in volume, of 1000 μm, preferably 500 μm, more preferably 200 μm. Particle size is measured by laser diffraction where all particles are considered to be spheres. The apparatus used is the Sympatec HELOS/KR sensor using the Fraunhofer method.

One particularly advantageous manner for preparing CSH is to replace 2 to 4%, preferably about 3% of silica by freshly prepared colloidal silica. To do so, a dilute acid (H₂SO₄, HCl, . . . ) is reacted with a sodium silicate solution. This way of proceeding is called the “amplified method” as in the present invention.

A comparative table between the CSH disclosed in WO 00/48710 and that of the present invention shows the following main differences:

| | Ca/Si | H₂O/Ca | | Specific |
|---|---|---|---|---|
| Param. | (molar ratio) | (molar ratio) | Particle size | surface area |
| WO | 1 to 5 | 0.1 to 2 | 0.5 to 30 mm | BET > 120 m²/g |
| 00/48710 | 1.54 to 5 (preferred) | 0.1 to 1 (preferred) | | |
| | 1.54 to 2.5 (+preferred) | 0.25 to 1 (+preferred) | | |
| Present | 1.55 < Ca/Si < 1.72 | 0.1 to 2 | <1000 μm | BET > 120 m²/g |
| invention | preferred | 0.1 to 1 | preferred | preferred |
| | 1.65 < Ca/Si < 1.72 | 0.25 to 1 | <500 μm | >150 m²/g |
| | | | <300 μm | PV > 0.4 cm³/g |

The fresh colloidal silica used in small amount (1 to 5%) in the silica mixture allows to increase the BET up to 200 m²/g and a pore volume PV>0.5 cm³/g. The pore volume is measured using the BJH method (barret-Joyner-Halenda).

“Ca” solely represents the calcium content that may react with silica. If one of the reagents (lime or silica) contains calcium carbonate that does not take part in hydrothermal synthesis of CSH, this calcium is not taken into consideration for calculating the Ca/Si ratio. This calcium carbonate is assayed by thermogravimetry.

The highly specific Ca/Si ratios in the CSH gels as in the present invention have the advantage that they release Ca(OH)₂ which, in an aqueous medium, ionises to Ca++ and hydroxyl (OH⁻) ions neutralising the acidic gases.

It was possible to show that for Ca/Si molar ratios < or =1.72, only CSH is formed. With higher ratios, a mixture of CSH and calcium hydrate is obtained. With a Ca/Si ratio>1.72, CSH is therefore diluted with calcium hydrate and the performance level drops.

The CSH gels comprise water in three different forms:
1) capillary contact water between CSH particles: We
2) water contained in CSH pores: Wp
3) constituent water of calcium silicate gel: Wg
Total water Wt=We+Wp+Wg.

When said product is subjected to thermogravimetric analysis, four regions are observed:
1) from 25 to 150° C., the capillary contact water and water contained in the pores are evaporated
2) from 350 to 500° C., Ca(OH)₂ is dehydrated to CaO and H₂O
3) from 550 to 800° C., constituent CSH water is released
4) from 800 to 1000° C., CaCO₃ is decarbonated, possibly having three origins:
   a. impurity from amorphous silica
   b. quicklime impurity
   c. carbonation of CSH and decalcification thereof.

The uptake of acidic gases (SO₂, SO₃, HCl, HF) by a porous solid only truly performs well when the pores of this solid are partly or totally filled with water and dissolved salts. These gases dissolve in pore water where the calcium hydrate has also dissolved. The acid-base reaction between Ca(OH)₂ and the acidic gases occurs in a medium dissolved in the pores, and then the formed gypsum and/or calcium chloride are deposited on the inner surface of the pores.

In dry calcium hydrates with pore volumes of between 0.08 and 0.2 cm³/g, water is provided by the flue gases and preferably condenses in pores via capillary effect. In the scenario of the present invention, water is already contained in the pores as from the manufacture of the porous solid and Ca(OH)₂ is already dissolved therein ready to react with the acidic gases.

By adding a chloride salt during CSH synthesis (e.g. sodium chloride, calcium chloride or iron chloride), chlorine forms calcium chloride hydrates in the pores which progressively release crystallization water during contact with the hot gases. They thereby release water that is available for the dissolution of the acidic gases:
CaCl₂.6H₂O stable below 30° C.;
CaCL₂.4H₂O stable from 30 to 45° C.;
CaCl₂.2H₂O stable from 45 to 87° C.
   Performance tests showed a most beneficial effect of chlorine in the reagent to treat HCl-depleted gases.

The following table compares the efficiency of different sorbents tested in an incinerator. The specific surface area (BET-Brunauer-Emmett-Teiler) of the powders was measured in accordance with ISO standard 9277, second Edition, Sep. 1^{st} 2010. Calculation of pore distribution was based on the step-by-step analysis of the isotherm adsorption branch using the BJH method by Barret, Joyner and Halenda (1951) conventionally used with 77K nitrogen as adsorbent gas. The method is described in DIN standard 66134.

Sorbent Chemical Reactions

1) Ca(OH)₂+SO₂+1/2 6O₂=>CaSO₄+H₂O.

2) (CaO)ₓ(.SiO₂)_{y}.(H₂O)_{z}+x SO₂+x/2 O₂=>CaSO₄+y SiO₂+z H₂O.

1.6 <X/Y<1.72

0.25<Z/X<1

The capture reaction of pollutants such as sulfur oxide by CSH releases silica and CSH constituent water. Only the lime contained in the CSH molecule reacts with the pollutant. CSH therefore has the drawback of containing a larger amount of material that does not participate in the capture reaction of the pollutant, than calcium hydrate. Nevertheless, this drawback is largely offset by the greater reactivity of CSH towards the pollutant on account of its large specific surface area and high pore volume.

| | | | CSH | CSH |
|---|---|---|---|---|
| | | | (without fresh | (with fresh |
| | | | precipitated | precipitated |
| | Standard | Improved | silica) of the | silica) of the |
| Sorbents | Ca(OH)₂ | Ca(OH)₂ | invention | invention |
| Access to alkalinity | 34% | 50% | 87% | 95% |
| i.e. Ca(OH)₂* | | | | |
| BET in m²/g | 22 | 40 | >120 | >150-(200) |
| PV in cm³/g | 0.08 | 0.2 | >0.4 | >0.6 |
| % alkalinity | 90% Ca(OH₎₂ | 95% Ca(OH)₂ | 63% Ca(OH)₂ | 63% Ca(OH)₂ |
| Kg alkalinity i.e. | 34*0.9 = 30.6 kg | 50*0.95 = 47.5 kg | 87*0.63 = 54.8 kg | 95*0.63 = 60 kg |
| effective Ca(OH)₂ | | | | |
| (i.e. reacting with SO₂) | | | | |
| per 100 kg of product | | | | |

*Access to alkalinity is obtained by analysing the sorbent after its exposure to synthetic flue gases containing O₂, N₂, SO₂, HCl and CO₂. The % of Ca(OH)₂ derived from a hydrate or from a CSH combined with SO₂ and/or HCl, relative to the total available hydrate, expresses access of SO₂ and HCl polluting gases to the alkalinity of the Ca(OH)₂ used.
The CSH as in the invention contains more accessible alkalinity per 100 kg of product and therefore generates less waste per kg of captured SO₂; which is a major advantage since disposal costs are lower.

### Modes for Synthetizing CSH Milky Slurries

CSH synthesis may be conducted at atmospheric pressure at about 95° C. for about 3 hours, or at high pressure (between 5 and 10 bars corresponding to saturating vapour temperatures of between 150 and 180° C.). Since the synthesis times are shortened under these conditions (about 30 minutes), synthesis can be carried out in batch mode or continuous mode in a thermostat-controlled reactor of coil type or simply insulated against heat loss.

Numerous syntheses performed in laboratory and on semi-industrial scale (from 0.5 m³ to 25 m³) show that the surface properties of CSH are not dependent on the surface properties of the amorphous silicas used for the production thereof; in contrast, the addition of a small amount of freshly synthesised colloidal silica (about 3% of total silica) has a considerable impact on surface quality.

The synthesis of colloidal silica is performed by reacting dilute sulfuric acid with sodium silicate in solution. The colloidal silica is left to stand a few minutes until it precipitates and forms a milky suspension. Amorphous silica (diatomaceous earth, silica fume, . . . ) and quicklime are then added to obtain synthesis of the CSH suspension.

### Drying Modes of CSH Milky Slurries as in the Invention

The purpose of drying is to reduce the humidity percentage of the sorbent from about 78% free water to 5-20% free water, to obtain a powder sorbent having adequate flow properties.

### Drying of CSH Milky Slurry at Atmospheric Pressure and Temperature Below 500° C. (to Prevent Deterioration of CSH Hydration)

Calories may be obtained by burning a fossil fuel or by recovering lost calories (lime rotary furnaces without preheater, cement kilns, etc.) via a heat exchanger.

The calories can be conveyed by:
1) CO₂-depleted air (to prevent carbonatation of the CSH gel);
2) nitrogen (costly solution);
3) water vapour which has the advantage of having twice the specific heat of air and therefore capable of conveying twice more calories at the same temperature.

### Drying the CSH Milky Slurry Under Pressure

When CSH is produced under pressure, e.g. at 150° C. and at a pressure higher than 5 bar, by expansion at atmospheric pressure, the CSH free water evaporates when the paste is spray dried.

### Measuring the Performance of the CSH of the Invention

Essentially three systems are distinguished to measure the performance of a sorbent:
1) Breakthrough method on 10 g of granulate powder or 250 mg of fine powder. This method is performed on a dry powder and therefore does not reflect industrial reality. In this method, a “breakthrough time” is defined which is the time required for the concentration of pollutants leaving the bed to be equal to the concentration of incoming pollutants. This breakthrough time is the image of sorbent performance.
2) In-flight uptake method
   A powder sorbent is poured into a vertical cylinder a few metres high. Recomposed flue gases pass through the cylinder and meet the sorbent in counter flow. Reacted sorbent deposits at the bottom of the cylinder. A filter collects the fine powder particles entrained by the flue gases. This method has the drawback that uniform distribution of the powder throughout the entire cross-section of the cylinder is not certain.
3) Reduced-scale simulation of the operation of an industrial bag filter used to depollute flue gases
   This system was chosen to test the performance of the sorbents of the present invention since it comes closest to true conditions of use.
The bag filter has a filtering surface of 35 m², i.e. 12 rows of 5 bags per row. One bag therefore has a lateral surface area of 0.58 m², a perimeter of 0.58 m and length of 1 m. As in any industrial filter, the sorbent is continuously directed into the bags and the twelve rows of bags are regularly pulsed with compressed air, row after row, with an adjustable cycle time of 30 to 60 minutes. The filter rate of flue gases is 1 m/minute and the flow of recomposed flue gases may be adjusted depending on filtering temperature to take heed of this filter speed.

### EXAMPLES

CSH milk was synthetized in a laboratory PARR reactor. CSH was synthetized for three hours at different temperatures. For amplified CSH, 3% fresh colloidal silica was added during synthesis.

The variation in structural characteristics depending on temperature of CSH synthesis, accelerated and non-accelerated, are given in the table below.

Diatomite from Cekesa (Spain) was used having a specific surface area of 103 m²/g and pore volume of 0.29 cm³/g containing 72% SiO₂; 27.2% CaCO₃ and 0.8% (Al₂O₃+MgO).

Examples 1 to 6 were conducted with a Ca/Si ratio of 1.7; Examples 7 to 9 with a Ca/Si ratio of 1.55 and Examples 10 to 12 with a Ca/Si ratio of 1.72. Tests 7 to 12 were conducted in the region of temperatures that were considered to be the most favourable in tests 1 to 6.

| | | | BET | PV | BET | PV |
|---|---|---|---|---|---|---|
| | | | (m²/g) | (cc/g) | (m²/g) | (cc/g) |
| | T | | non-amplified with | | amplified with fresh | |
| Example | (° C.) | Ca/Si | fresh colloidal silica | | colloidal silica | |
| 1 | 95 | 1.7 | 120 | 0.42 | 180 | 0.6 |
| 2 | 120 | 1.7 | 130 | 0.40 | 185 | 0.6 |
| 3 | 140 | 1.7 | 160 | 0.50 | 200 | 0.9 |
| 4 | 150 | 1.7 | 198 | 0.64 | 220 | 1.1 |
| 5 | 160 | 1.7 | 170 | 0.52 | 200 | 0.9 |
| 6 | 180 | 1.7 | 130 | 0.40 | 180 | 0.6 |
| 7 | 140 | 1.55 | 142 | 0.48 | 190 | 0.9 |
| 8 | 150 | 1.55 | 150 | 0.59 | 210 | 1.0 |
| 9 | 160 | 1.55 | 138 | 0.50 | 185 | 0.8 |
| 10 | 140 | 1.72 | 160 | 0.45 | 192 | 0.7 |
| 11 | 150 | 1.72 | 195 | 0.51 | 212 | 0.9 |
| 12 | 160 | 1.72 | 165 | 0.47 | 205 | 0.8 |

It is noted that in the region of 150° C., the specific surface areas and pore volume are the largest and hence the most favourable for depolluting flue gases.

Performance Comparison

Comparison between pollution uptake performances by reduced-scale simulated operation of an industrial bag filter used to depollute flue gases

The performance of the CSH as in the invention was compared with Ca(OH)₂ products. The CSH synthesis conditions were those conducted at 150° C. and at 5 bars for three hours. The CSH milky slurry was spray dried in an atomizer without direct contact with fumes from the hot-air generator operating on natural gas. There remained 15% residual water after drying. The indication “kg of acid” means total weight of SO₂ and HCl.

Different flue gas compositions were tested and the results are given in the following table.

Flue gas composition No 1:
1000 mg/Nm³SO₂ and 1000 mg/Nm³HCl at 160° C., 10% H₂O, 5% CO₂

| | % uptake of acid in flue gases | | |
|---|---|---|---|
| | 2 kg sorbent/ | 3 kg sorbent/ | 4 kg sorbent/ |
| Type of sorbent | kg acid | kg acid | kg acid |
| CSH of the | SO₂ = 74%/ | SO₂ = 83%/ | SO2 = 90%/ |
| invention | HCl = 96% | HCl = 99% | HCl = 99.5% |
| CSH amplified | SO₂ = 78%/ | SO₂ = 86%/ | SO₂ = 76%/ |
| with fresh silica | HCl = 98% | HCl = 100% | HCl = 100% |
| Ca(OH)₂ | SO₂ = 62%/ | SO₂ = 70%/ | SO₂ = 76%/ |
| BET = 40 m²/g & | HCl = 93% | HCl = 96% | HCl = 98% |
| PV = 0.2 cm³/g | | | |
| Ca(OH)2 | SO₂ = 38%/ | SO₂ = 43%/ | SO₂ = 51%/ |
| BET = 22 m2/g& | HCl = 60% | HCl = 70% | HCl = 74% |
| PV = 0.1 cm3/g | | | |

Flue gas composition No 2:
250 mg/Nm³SO₂ and 1000 mg/Nm³ HCl at 160° C., 10% H₂O, 5% CO₂

| | % uptake of acid in flue gases | | |
|---|---|---|---|
| | 2 kg sorbent/ | 3 kg sorbent/ | 4 kg sorbent/ |
| Type of sorbent | kg acid | kg acid | kg acid |
| CSH of the | SO₂ = 86%/ | SO₂ = 92%/ | SO₂ = 99%/ |
| invention | HCl = 91% | HCl = 96% | HCl = 99% |
| CSH amplified | SO₂ = 90%/ | SO₂ = 94%/ | SO₂ = 100%/ |
| with fresh silica | HCl = 94% | HCl = 98% | HCl = 100% |
| Ca(OH)₂ | SO₂ = 74%/ | SO₂ = 83%/ | SO₂ = 94%/ |
| BET = 40 m²/g & | HCl = 83% | HCl = 94% | HCl = 98% |
| PV = 0.2 cm³/g | | | |
| Ca(OH)₂ | SO₂ = 64%/ | SO₂ = 68%/ | SO₂ = 69%/ |
| BET = 22 m²/g & | HCl = 60% | HCl = 5% | HCl = 69% |
| PV = 0.1 cm³/g | | | |

Flue gas composition No 3:
1000 mg/Nm³SO₂ and 0 mg/Nm³HCl at 160° C., 10% H₂O, 5% CO₂

| | % uptake of acid in flue gases | | |
|---|---|---|---|
| | 2 kg sorbent/ | 3 kg sorbent/ | 1 kg sorbent/ |
| Type of sorbent | kg acid | kg acid | kg acic |
| CSH of the | SO₂ = 50% | SO₂ = 52% | SO₂ = 60% |
| invention | | | |
| CSH amplified with | SO₂ = 55% | SO₂ = 60% | SO₂ = 65% |
| fresh silica | | | |
| Ca(OH)₂ | SO₂ = 42% | SO₂ = 50% | SO₂ = 55% |
| BET = 40 m²/g & | | | |
| PV = 0.2 cm³/g | | | |

Comparing the performance tests shows the advantage of the CSH as in the invention, in particular when it is amplified with fresh silica, compared to the two Ca(OH)₂ versions used for comparison in the comparative tests.

1-12. (canceled)

1. Sorbent for the treatment of gases, having an active phase comprising a calcium silicate hydrate of (CaO)ₓ(SiO₂)_{y}(H₂O), type with a Ca/Si molar ratio of between 1.55 and 1.72, preferably between 1.65 and 1.72, and a H₂O/Ca molar ratio of between 1 and 1.4, preferably between 1.1 and 1.3, “z” being between 0.3 and 0.8, the sorbent having a specific surface area larger than 150 m²/g, and preferably larger than 200 m²/g, with a pore volume greater than 0.6 cm³/g, and preferably greater than 0.8 cm³/g.

2. The sorbent as in claim 1, wherein the mean particle size (D50) is less than 1000 μm, preferably less than 500 μm, and more preferably less than 300 μm.

3. The sorbent as in claim 1, further comprising sodium chloride, calcium chloride or iron chloride hydrate in its pores.

4. The sorbent as in claim 1, further comprising a fluidifying agent selected from among monoethanol amine, diethanol-amine, triethanol-amine, monoethylene-glycol, diethylene glycol and triethylene-glycol.

5. Method for preparing a sorbent as in claim 1, wherein the calcium silicate hydrate is obtained by:
preparing an aqueous suspension of silica and lime, from colloidal silica, silica fume or diatomaceous earth, the aqueous silica suspension comprising a proportion of 1 to 5%, preferably 2 to 4% of colloidal silica freshly synthesised by causing a sodium silicate solution to react with a dilute acid until a milky suspension of a precipitate of colloidal silica is obtained within a few minutes, before adding the amorphous silica via the silica fume or diatomaceous earth and quicklime to obtain said calcium silicate hydrate; drying under heat.

6. The preparation method as in claim 5, wherein the silica fume or diatomaceous earth or mixture of these ingredients is previously milled to obtain particles having a d50 diameter of less than 30 μm.

7. The preparation method as in claim 5, further comprising a step to add a chlorine salt, preferably sodium chloride, calcium chloride or iron chloride.

8. Process for treating gases by means of a sorbent, wherein a sorbent as in claim 1 is placed in contact with the gases to be treated.

9. The treatment process as in claim 8, wherein it is a dry process in which the gases are placed in direct contact with the sorbent.

10. The treatment process as in claim 8, wherein that the gases to be treated pass through an electro-filter or bag filter containing the sorbent.

11. The treatment process as in claim 8, wherein the concentration of SO₂ is measured, as indicator compound, in the gases leaving the electro-filter or bag filter, and wherein the sorbent is replaced when the concentration exceeds a previously-set limit value.
